(19) United States
(12) Patent Application Publication
(10) Pub. No.: US 2008/0080949 A1
(43) Pub. Date: Apr. 3, 2008

(54) Spring toggle

(76) Inventors: Jinn-Yi Deng, Changhua Hsien (TW); Shwu-Fen Hwang, Changhua Hsien (TW)

Correspondence Address: RABIN & Berdo, PC, 1101 14TH STREET, NW, SUITE 500, WASHINGTON, DC, 20005, US

(21) Appl. No.: 11/522,339

(22) Filed: Sep. 18, 2006

(51) Int. Cl. F16B 21/00

(52) U.S. Cl. 411/342

(57) ABSTRACT

A spring toggle includes an outer wing, an inner wing, a spring and a bolt. The outer and inner wings each include a limb, a clipping flange and two sidewalls. The limb has a proximal end, a distal end and two edges. The clipping flange is formed on the proximal end of the limb. The sidewalls are formed respectively on the edges of the limb. The spring is mounted in the inner and outer wings. The bolt is inserted through the spring, extends between the clipping flanges of the inner and outer wings and has an outer thread. The outer thread of the bolt is clipped by the clipping flanges when the inner and outer wings are expanded by the spring.

### BACKGROUND OF THE INVENTION

1. Field of Invention

The present invention relates to a toggle, and more particularly to a spring toggle that can be fastened tightly and easily.

2. Description of the Related Art

With reference to FIGS. 7 and 8, a conventional spring toggle comprises two wings (60), a pivoting element (70), a spring (80) and a bolt (90). The wings (60) are mounted pivotally to each other and each wing (60) has two sidewalls (61). Each sidewall (61) has a pivoting end (611) and a through hole (612) defined through the sidewall (61) near the pivoting end (611). The through holes (612) in the wings (60) are aligned with each other. The pivoting element (70) is mounted between the sidewalls (61) of the wings (60) and has an inner thread (71) and two arms (72). The arms (72) of the pivoting element (70) are respectively mounted in and extend through the through holes (612) of the wings (60). The spring (80) is mounted around one arm (72) of the pivoting element (70) and has two legs (81). The legs (81) abut respectively with the wings (60) to expand the wings (60). The bolt (90) is mounted between the wings (60) and has an outer thread (91). The outer thread (91) is screwed into the inner thread (71) of the pivoting element (70).

When the conventional spring toggle is in use, the wings (60) are compressed to abut with the bolt (90) and the spring toggle is inserted into a fastening hole through a wall or a ceiling. After the compressed wings (60) extend through the fastening hole in the wall or ceiling, the wings (60) are expanded with the resilient force provided by the spring (80) and the wings (60) abut against the wall or ceiling as the bolt (90) being pulled backward to prevent the spring toggle being escaping from the fastening hole. With rotating the bolt (90), the position of the bolt (90) can be adjusted with the engagement between the outer thread (91) and the inner thread (71)

The conventional spring toggle as described has following disadvantages. The pivoting element (70) is a thin sheet and the length of the inner thread (71) in the pivoting element (70) is so short. Therefore, the bolt (90) can not be mounted in the pivoting element (70) tightly and easily falls out from the pivoting element (70) when a heavy weight is loaded onto the bolt (90). In addition, to rotate the bolt (90) is necessary for adjusting the position of the bolt (90) and this is inconvenient and time-consuming.

To overcome the shortcomings, the present invention provides a spring toggle to mitigate or obviate the aforementioned problems.

### SUMMARY OF THE INVENTION

The primary objective of the present invention is to provide a spring toggle that can be fastened in a wall or a ceiling tightly and easily.

The spring toggle in accordance with the present invention comprises an outer wing, an inner wing, a spring and a bolt. The outer wing comprises a limb, a clipping flange and two sidewalls. The limb has a proximal end, a distal end, two edges and a mounting element. The mounting element is formed on the limb near the distal end. The clipping flange is formed on the proximal end of the limb. The sidewalls are formed respectively on the edges of the limb and each has a protruding end and a through hole. The protruding end is protrudent relative to the proximal end of the limb. The through hole is defined through the sidewall near the protruding end.

The inner wing is mounted pivotally on the outer wing and comprises a limb, a clipping flange and two sidewalls. The limb is narrower than the limb of the outer wing and has a proximal end, a distal end, two edges and a mounting element. The mounting element is formed on the limb near the distal end. The clipping flange is formed on the proximal end of the limb. The sidewalls are formed respectively on the edges of the limb and each has a protruding end, a through hole and a mounting flange. The protruding end is protrudent relative to the proximal end of the limb. The through hole is defined through the sidewall near the protruding end. The mounting flange is formed around the through hole and mounted in the through hole of one of sidewalls of the outer wing.

The spring is mounted in the inner and outer wings and has a body and two legs. The legs are connected to the body, are engaged respectively with the inner and outer wings and each has a mounting end. The mounting end is engaged with the mounting element of one of the limbs.

The bolt is inserted through the body of the spring, extends between the clipping flanges of the inner and outer wings and has an outer thread. The outer thread of the bolt is clipped by the clipping flanges.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a spring toggle in accordance with the present invention;

FIG. 2 is a side view of the first embodiment of the spring toggle in FIG. 1;

FIG. 3 is a cross sectional bottom view of the first embodiment of the spring toggle in FIG. 1;

FIG. 4 is a side view in partial section of the first embodiment of the spring toggle in FIG. 1;

FIG. 5 is an operational side view in partial section of the first embodiment of the spring toggle in FIG. 1 with the outer and inner wings being compressed;

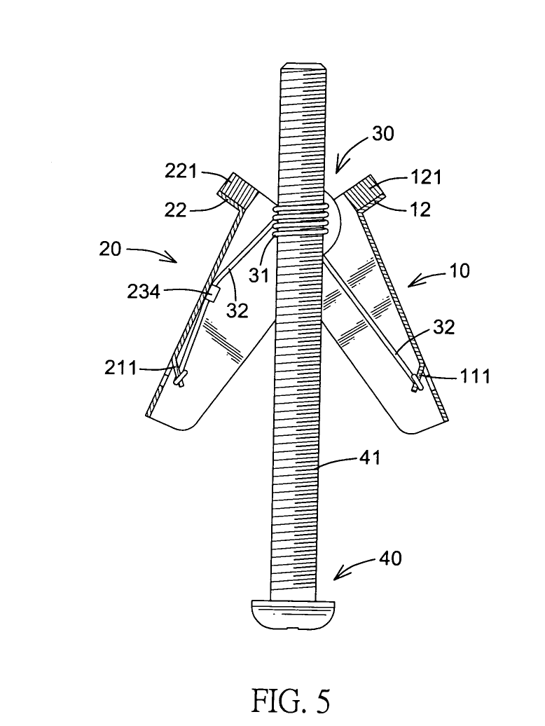

FIG. 6 is a side view in partial section of a second embodiment of a spring toggle in accordance with the present invention;

FIG. 7 is an exploded perspective view of a conventional spring toggle in accordance with the prior art; and

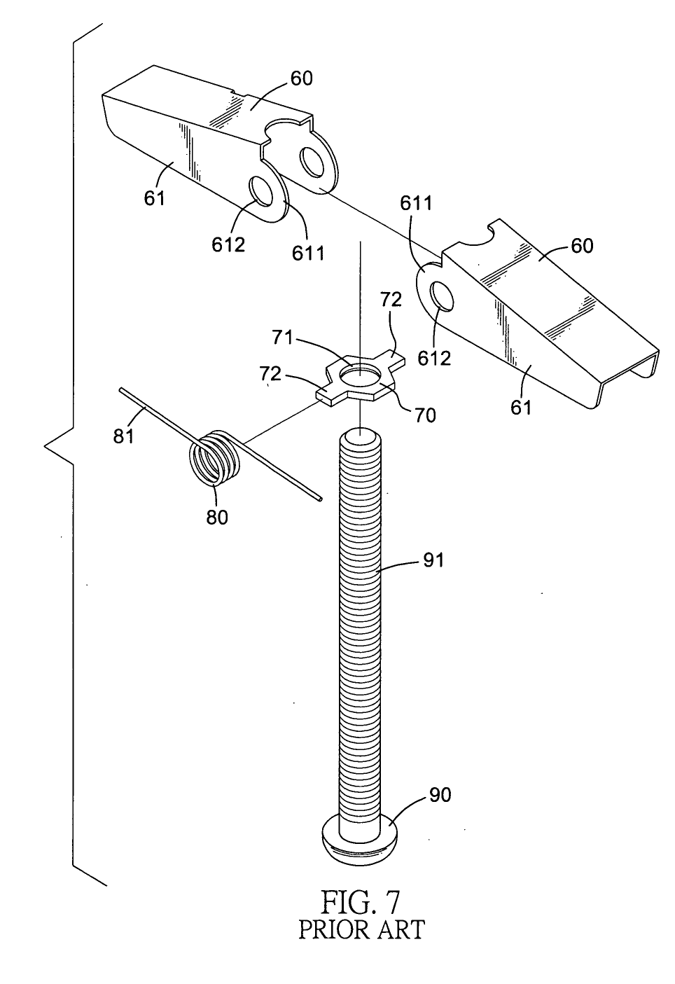

FIG. 8 is a cross sectional side view of the conventional spring toggle in FIG. 7.

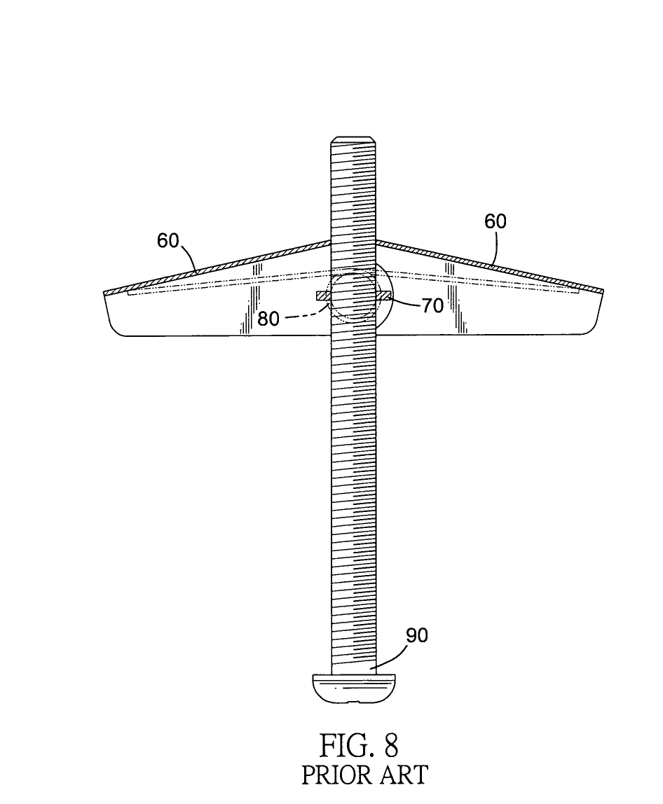

### DETAILED DESCRIPTION OF THE INVENTION

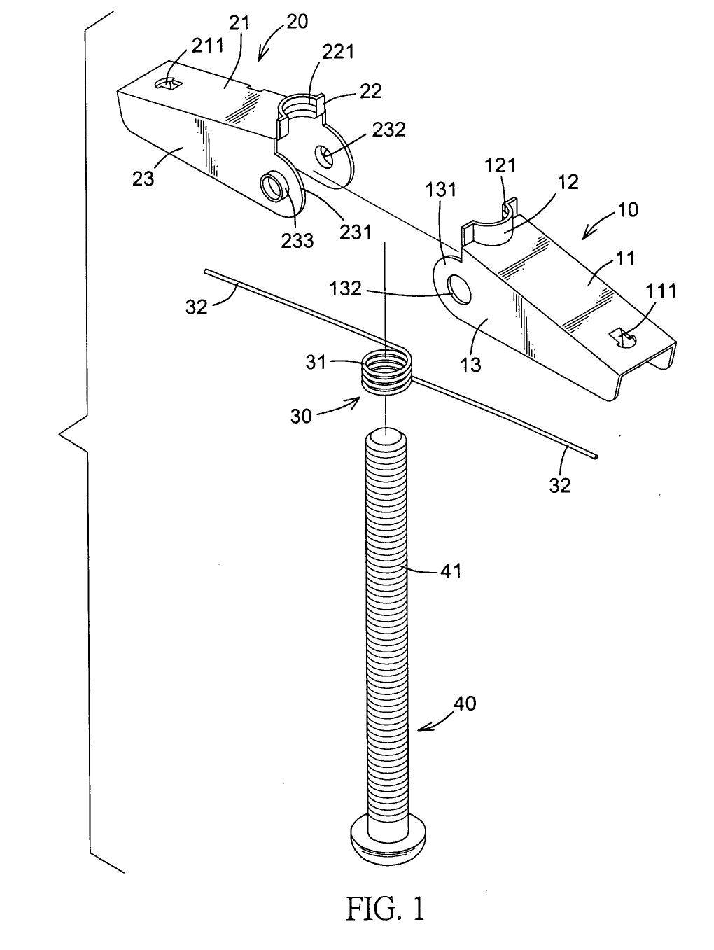

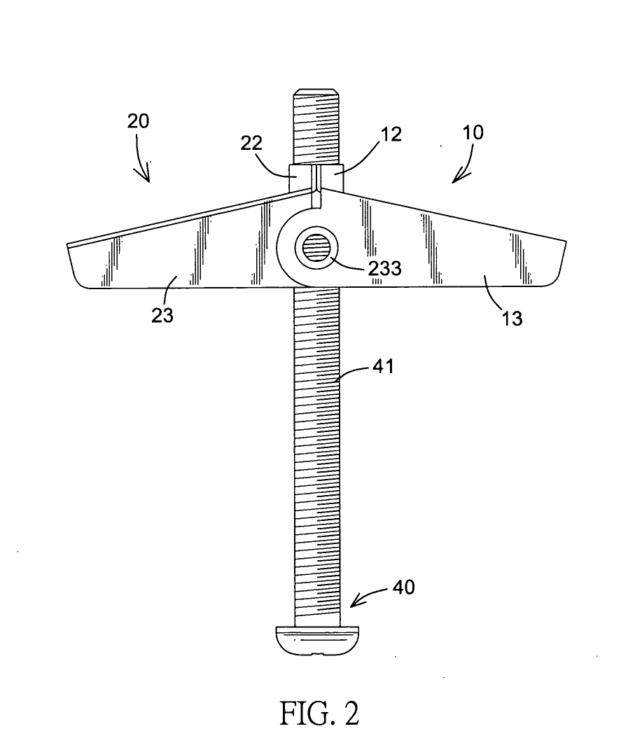

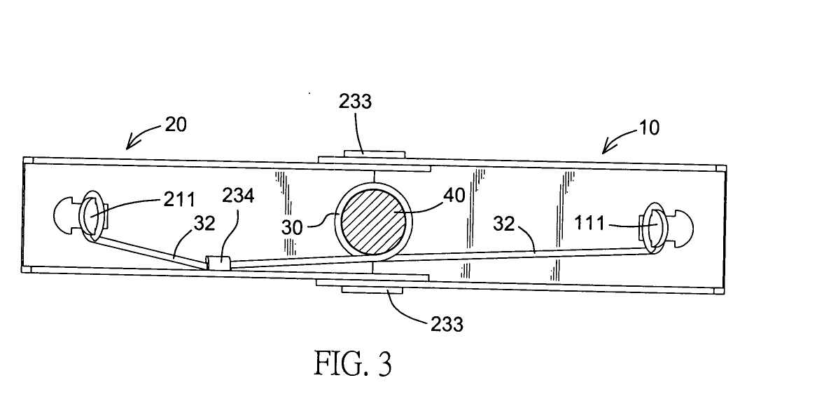

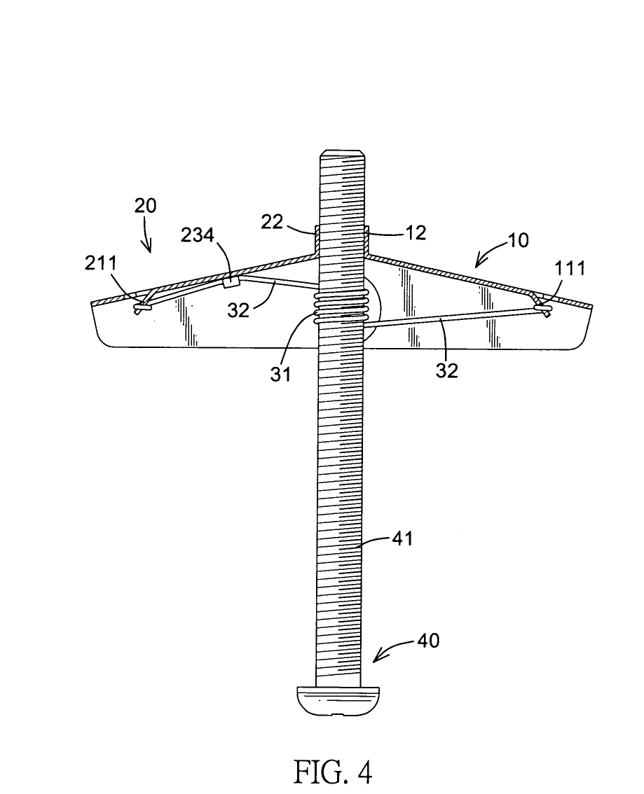

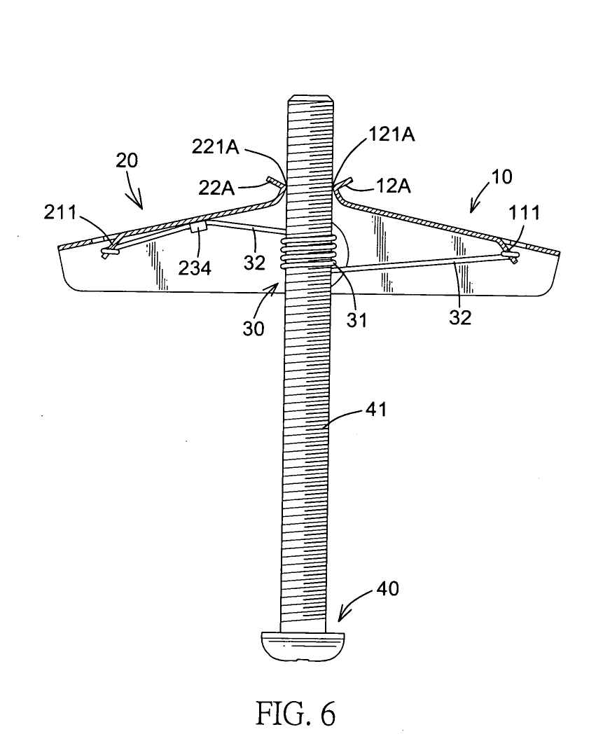

With reference to FIGS. 1, 2, 3 and 4, a spring toggle in accordance with the present invention comprises an outer wing (10), an inner wing (20), a spring (30) and a bolt (40). The outer wing (10) comprises a limb (11), a clipping flange (12, 12A) and two sidewalls (13). The limb (11) is a rectangular sheet and has a proximal end, a distal end, two edges and a mounting element (111). The mounting element (111) is formed on the limb (11) near the distal end. With further reference to FIG. 6, the clipping flange (12, 12A) is formed on the proximal end of the limb (11) and may be curved or inclined relative to the limb (11). The sidewalls (13) are formed perpendicularly and respectively on the edges of the limb (11) and each has a protruding end (131) and a through hole (132). The protruding end (131) of the sidewall (13) is curved and protrudent relative to the proximal end of the limb (11). The through hole (132) is defined through the sidewall (13) near the protruding end (131).

In a first embodiment in accordance with the present invention, the clipping flange (12) of the outer wing (10) is curved and has an inner thread (121).

In a second embodiment in accordance with the present invention, the clipping flange (12A) of the outer wing (10) is inclined relative to the limb (11) and has a tip (121A).

The inner wing (20) is mounted pivotally on the outer wing (10) and comprises a limb (21), a clipping flange (22) and two sidewalls (23). The limb (21) is a rectangular sheet, slightly narrower than that of the outer wing (10) and has a proximal end, a distal end, two edges and a mounting element (211). The mounting element (211) is formed on the limb (21) near the distal end. The clipping flange (22, 22A) is formed on the proximal end of the limb (21) and may be curved or inclined relative to the limb (21). The sidewalls (23) are formed perpendicularly and respectively on the edges of the limb (21) and each has a protruding end (231), a through hole (232) and a mounting flange (233). The protruding end (231) of the sidewall (23) is curved and protrudent relative to the proximal end of the limb (21). The through hole (232) is defined through the sidewall (23) near the protruding end (231). The mounting flange (233) is formed around the through hole (232) and is mounted in the through hole (132) of one of the sidewalls (13) of the outer wing (10). The mounting flanges (233) is riveted to connect the inner and outer wings (10, 20) stably. One of the sidewalls (23) further has a fastening element (234) form on the sidewall (23).

In the first embodiment, the clipping flange (22) of the inner wing (20) is curved and has an inner thread (221).

In the second embodiment, the clipping flange (22A) of the inner wing (20) is inclined relative to the limb (21) and has a tip (221A).

The spring (30) is mounted in the inner and outer wings (10, 20) and has a body (31) and two legs (32). The body (31) is mounted between the sidewalls (13, 23) of the inner and outer wings (10, 20). The legs (32) are connected to the body (31), are engaged respectively with the inner and outer wings (10, 20) and each has a mounting end. One of the legs (32) and extends through the fastening element (234) of on the limb (21) of the inner wing (20) and is fastened on and engaged with the mounting element (211) of the inner wing (20). The mounting ends of the legs (32) are engaged respectively with the mounting elements (111, 211) of the limbs (11, 21) of the wings (10, 20). When the inner and outer wings (10, 20) are compressed toward each other, the spring (30) is also compressed to be capable of expanding the inner and outer wings (10, 20).

The bolt (40) is inserted through the body (31) of the spring (30) and extends between the clipping flanges (12, 22, 12A, 22A) of the inner and outer wings (10, 20) and has an outer thread (41). In the first embodiment, the outer thread (41) corresponds to and is selectively clipped by the inner threads (121, 221) of the clipping flanges (12, 22). When the inner and outer wings (10, 20) are expanded, the outer thread (41) of the bolt (40) is clipped by the inner threads (121, 221) of the clipping flanges (12, 22) or the tips (121A, 221A) of the clipping flanges (12A, 22). When the inner and outer wings (10, 20) are compressed slightly to make the bolt (40) being released from the clipping flanges (12, 22), the bolt (40) can be moved slidably relative to the body (31) of the spring (30) to any suitable position without rotating the bolt (40). Therefore, to adjust the position of the bolt (40) is easy and convenient.

When the spring toggle is in use, the outer and inner wings (10, 20) are compressed fully against the bolt (40) and the spring toggle is inserted into a fastening hole through a wall or a ceiling. When the inner and outer wings (10, 20) are compressed fully against the bolt (40), the body (31) of the spring (30) will be compressed to securely hold and keep the bolt (40) from moving relative to the body (31). Thus, the bolt (40) will not be moved relative to the spring (30) and the outer and inner wings (10, 20) during the travel of inserting the spring toggle into the fastening hole. After the outer and inner wings (10, 20) extend out of the fastening hole in the wall or ceiling, the outer and inner wings (10, 20) are expanded by the spring (30) and abut the wall or ceiling when the bolt (40) is pulled backward. Consequently, the spring toggle is prevented from being escaped from the fastening hole. When the outer and inner wings (10, 20) are expanded, the bolt (40) is clipped with the clipping flanges (12, 12A, 22, 22A) of the outer and inner wings (10, 20) to hold the bolt (40) in a desired place. With the abutment between the outer and inner wings (10, 20) and the wall or ceiling, a force for pushing the clipping flanges (12, 12A, 22, 22A) toward each other is applied to the outer and inner wings (10, 20) when an external force is applied to pull the bolt (40) downward. Accordingly, the bolt (40) is clipped tightly between the clipping flanges (12, 12A, 22, 22A) and is kept from being pulled back even though a heavy weight is loaded onto the bolt (40).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A spring toggle comprising
an outer wing comprising
a limb having
a proximal end;
a distal end;
two edges; and
a mounting element being formed on the limb near the distal end of the limb of the outer wing;
a clipping flange being formed on the proximal end of the limb of the outer wing; and
two sidewalls being formed respectively on the edges of the limb of the outer wing and each having
a protruding end being protrudent relative to the proximal end of the limb of the outer wing; and
a through hole being defined through the sidewall near the protruding end of the limb of the outer wing;
an inner wing being mounted pivotally on the outer wing and comprising
a limb being narrower than the limb of the outer wing and having
a proximal end;
a distal end;
two edges; and
a mounting element being formed on the limb near the distal end of the limb of the inner wing;
a clipping flange being formed on the proximal end of the limb of the inner wing; and
two sidewalls being formed respectively on the edges of the limb of the inner wing and each having
a protruding end being protrudent relative to the proximal end of the limb of the inner wing;
a through hole being defined through the sidewall near the protruding end of the inner wing; and
a mounting flange being formed around the through hole in the sidewall and mounted in the through hole in one of sidewalls of the outer wing;
a spring being mounted in the inner and outer wings and having
a body; and
two legs being connected to the body, engaged respectively with the inner and outer wings and each having
a mounting end being engaged with the mounting element of one of the limbs; and
a bolt being inserted through the body of the spring, extending between and selectively clipped by the clipping flanges of the inner and outer wings and having
an outer thread being clipped by the clipping flanges on the inner and outer wings.

2. The spring toggle as claimed in claim 1, wherein
each clipping flange is curved and has an inner thread; and
the outer thread of the bolt corresponds to and is clipped by the inner threads of the clipping flanges.

3. The spring toggle as claimed in claim 2, wherein
one of the sidewalls further has a fastening element formed on the sidewall; and
one of the legs of the spring extends through the fastening element.

4. The spring toggle as claimed in claim 1, wherein
each clipping flange is inclined relative to a corresponding limb and has a tip; and
the outer thread of the bolt is clipped by the tips of the clipping flanges.

5. The spring toggle as claimed in claim 4, wherein
one of the sidewalls further has a fastening element formed on the sidewall; and
one of the legs of the spring extends through the fastening element.

6. The spring toggle as claimed in claim 1, wherein
one of the sidewalls further has a fastening element formed on the sidewall; and
one of the legs of the spring extends through the fastening element.
